(19) United States
(12) Patent Application Publication
(10) Pub. No.: US 2025/0093533 A1
(43) Pub. Date: Mar. 20, 2025

(54) RADIATION IMAGING APPARATUS, CONTROL METHOD THEREFOR, RADIATION IMAGING SYSTEM, AND STORAGE MEDIUM

(71) Applicant: CANON KABUSHIKI KAISHA, Tokyo (JP)

(72) Inventors: HIROKAZU OHGURI, Chiba (JP); HIDEAKI MORITA, Tokyo (JP); ASATO KOSUGE, Kanagawa (JP); YOSHIAKI SERIZAWA, Kanagawa (JP); HIROTO UENO, Kanagawa (JP)

(21) Appl. No.: 18/829,772

(22) Filed: Sep. 10, 2024

(30) Foreign Application Priority Data
Sep. 15, 2023 (JP) 2023-150165

(51) Int. Cl. G01T 1/175; G01T 1/24; G01T 7/00; G01T 7/12

(52) U.S. Cl. CPC G01T 1/175; G01T 1/247; G01T 7/005; G01T 7/12

(57) ABSTRACT

A radiation imaging apparatus that performs radiation imaging of a subject includes an image generation unit that generates a radiation image based on an incident radiation, and a control unit that, in a case where it is determined that at least any one of conditions including a positional relation between the radiation imaging apparatus and a radiation generation apparatus configured to generate the radiation, a positional relation between the subject and the radiation imaging apparatus, or a posture of the subject becomes a predetermined state in the radiation imaging, perform control so that a transition is made from a wait state in which a lower power consumption is provided than in an imaging-ready state in which the radiation is detectable by the image generation unit, to the imaging-ready state.

### BACKGROUND

### Field

The present disclosure relates to a radiation imaging apparatus, a control method for the radiation imaging apparatus, a radiation imaging system, and a storage medium.

### Description of the Related Art

Radiation imaging apparatuses for generating a digital radiation image based on an incident radiation have been widely used, and radiation imaging systems including radiation imaging apparatuses are currently being digitized. With the digitization of such radiation imaging systems, a radiation image can be checked immediately after the radiation imaging, greatly improving workflows in comparison with the conventional imaging method using a film or a Computed Radiography (CR) apparatus.

Further, wireless radiation imaging apparatuses have been developed, so that the radiation imaging apparatuses are becoming easy to be handled. Such a wireless radiation imaging apparatus operates on a battery, the number of imagings with single charging directly relates to the usability. In this case, power saving of the radiation imaging apparatus is required to increase the number of imagings. A digital radiation imaging apparatus requires a certain wait time because the apparatus needs to cancel a wait state in which a lower power consumption is provided than in an imaging-ready state, before a transition to the imaging-ready state. Japanese Patent Application Laid-Open No. 2002-165142 discusses a plurality of methods for canceling the wait state. This is because a time duration before imaging is desired as short as possible for an operator who performs the radiation imaging and a subject to be subjected to the radiation imaging. Japanese Patent Application Laid-Open No. 2002-272720 discusses a technique for canceling the wait state in response to an input of an imaging order, thus quickly performing the radiation imaging.

With the technique discussed in Japanese Patent Application Laid-Open No. 2002-165142, from the viewpoint of power saving, if an operator selects a method for canceling the wait state in which a time to be taken to cancel the wait state is too long with respect to the wait time before the radiation irradiation, the wait time for the operator increases, which can inhibit the operator from performing the radiation imaging at a suitable timing.

With the technique discussed in Japanese Patent Application Laid-Open No. 2002-272720, performing suitable radiation imaging is difficult in a case where a condition for executing the radiation imaging deviates from a predetermined state after an imaging order is input.

### SUMMARY

The present disclosure has been embodied in view of the above-described issues and is directed to providing a technique for performing suitable radiation imaging while maintaining power saving.

According to an aspect of the present disclosure, a radiation imaging apparatus configured to perform radiation imaging of a subject includes an image generation unit configured to generate a radiation image based on an incident radiation, and a control unit configured to, in a case where it is determined, based on a camera image captured by a camera and output data output from a detection sensor configured to detect at least either one of a position or a movement, that at least any one of conditions including a positional relation between the radiation imaging apparatus and a radiation generation apparatus configured to generate the radiation, a positional relation between the subject and the radiation imaging apparatus, or a posture of the subject becomes a predetermined state in the radiation imaging, perform control so that a transition is made from a wait state in which a lower power consumption is provided than in an imaging-ready state in which the radiation is detectable by the image generation unit, to the imaging-ready state.

Further features of the present disclosure will become apparent from the following description of exemplary embodiments with reference to the attached drawings.

### BRIEF DESCRIPTION OF THE DRAWINGS

FIG. 1 illustrates an example of an overall configuration of a radiation imaging system according to a first exemplary embodiment of the present disclosure.

FIG. 2 illustrates examples of internal functional configurations of a radiation imaging apparatus, a radiation generation apparatus, and a console illustrated in FIG. 1 in the radiation imaging system according to the first exemplary embodiment of the present disclosure.

FIG. 3 illustrates an example of an internal configuration of an image generation unit illustrated in FIG. 2 according to a first exemplary embodiment of the present disclosure.

FIG. 4 illustrates an example of a functional configuration of the radiation imaging apparatus illustrated in FIGS. 2 and 3.

FIG. 5 illustrates relations between a state and power consumption of the radiation imaging apparatus and elapsed time, and an example of an imaging processing flow of the radiation imaging apparatus according to the first exemplary embodiment of the present disclosure.

FIGS. 6A and 6B illustrate examples of display screens displayed on a display unit illustrated in FIG. 2 according to the first exemplary embodiment of the present disclosure.

FIG. 7 illustrates an example of an overall configuration of a radiation imaging system according to a second exemplary embodiment of the present disclosure.

FIG. 8 illustrates examples of internal functional configurations of the radiation imaging apparatus, the radiation generation apparatus, the console, and an interface (I/F) box illustrated in FIG. 7 in the radiation imaging system according to the second exemplary embodiment of the present disclosure.

FIG. 9 illustrates examples of drive timings of different apparatuses and a state of the radiation imaging apparatus in the radiation imaging system according to the second exemplary embodiment of the present disclosure.

FIG. 10 is a flowchart illustrating an example of processing in a method for controlling the radiation imaging apparatus according to the second exemplary embodiment of the present disclosure.

FIG. 11 illustrates an example of an overall configuration of a radiation imaging system according to a third exemplary embodiment of the present disclosure.

FIG. 12 is a flowchart illustrating an example of processing in a method for controlling a radiation imaging apparatus according to the third exemplary embodiment of the present disclosure.

### DESCRIPTION OF THE EMBODIMENTS

Exemplary embodiments of the present disclosure will be described below with reference to the accompanying drawings. The following exemplary embodiments of the present disclosure do not limit the present disclosure within the scope of the appended claims. Not all of the combinations of the features described in the exemplary embodiments of the present disclosure are indispensable to the solutions for the present disclosure. Although, according to the following exemplary embodiments of the present disclosure, X-ray is desirably used as radiation, the present disclosure is not limited thereto. For example, other radiations, such as an α ray, a β ray, and a γ ray, are also applicable to the present disclosure.

A first exemplary embodiment will be described below.

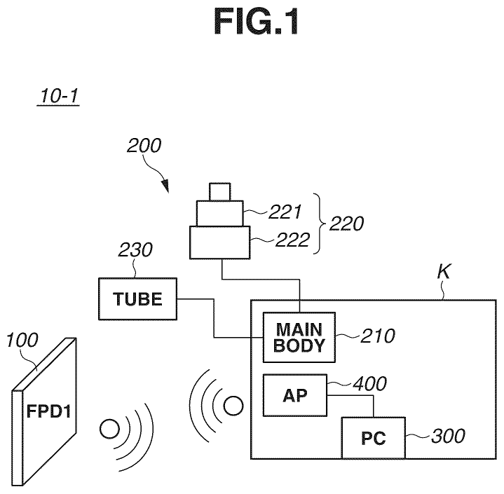

FIG. 1 illustrates an example of an overall configuration of a radiation imaging system 10-1 according to the first exemplary embodiment of the present disclosure.

As illustrated in FIG. 1, the radiation imaging system 10-1 includes a radiation imaging apparatus 100, a radiation generation apparatus 200, a console 300 (referred to as a “PC” in FIG. 1), and a wireless access point 400 (referred to as an “AP” in FIG. 1). The radiation generation apparatus 200 includes a radiation generation apparatus main body 210, a radiation switch 220, and a tube 230 serving as a radiation irradiation unit. As an example, the radiation imaging system 10-1 includes the radiation generation apparatus 200, the console 300, and the wireless access point 400 which are installed in a visiting car K.

The radiation imaging apparatus 100 is configured to wirelessly communicate with the wireless access point 400. The radiation imaging apparatus 100 operates on a battery or external power supply.

The radiation switch 220 includes a preparation request switch 221 used for issuing a radiation preparation start request to the radiation generation apparatus main body 210, and an irradiation request switch 222 used for issuing a radiation irradiation request thereto. The preparation request switch 221 and the irradiation request switch 222 are configured as a two-step switch. The preparation request switch 221 is to be pressed before the irradiation request switch 222. As illustrated in FIG. 1, if the radiation imaging apparatus 100 is used together with the visiting car K, the radiation imaging apparatus 100 wirelessly communicates with the wireless access point 400 and transmits a radiation image to the console 300. The radiation imaging apparatus 100 is configured to switch a wired communication connection by using a unit (not illustrated) instead of a wireless communication connection.

The console 300 is a control apparatus for controlling operations of the radiation imaging apparatus 100, the radiation generation apparatus 200, and the wireless access point 400.

The present exemplary embodiment is intended for a case where the radiation imaging apparatus 100 operates in an imaging mode in which the radiation imaging apparatus 100 itself detects the start of the radiation irradiation and performs an imaging operation. Therefore, the present exemplary embodiment provides no connection for direct signal communication between the radiation imaging apparatus 100 and the radiation generation apparatus 200. However, the configuration of the present exemplary embodiment is also applicable to the imaging mode in which the radiation imaging apparatus 100 and the radiation generation apparatus 200 perform handshaking to adjust the radiation irradiation timing in executing the imaging operation.

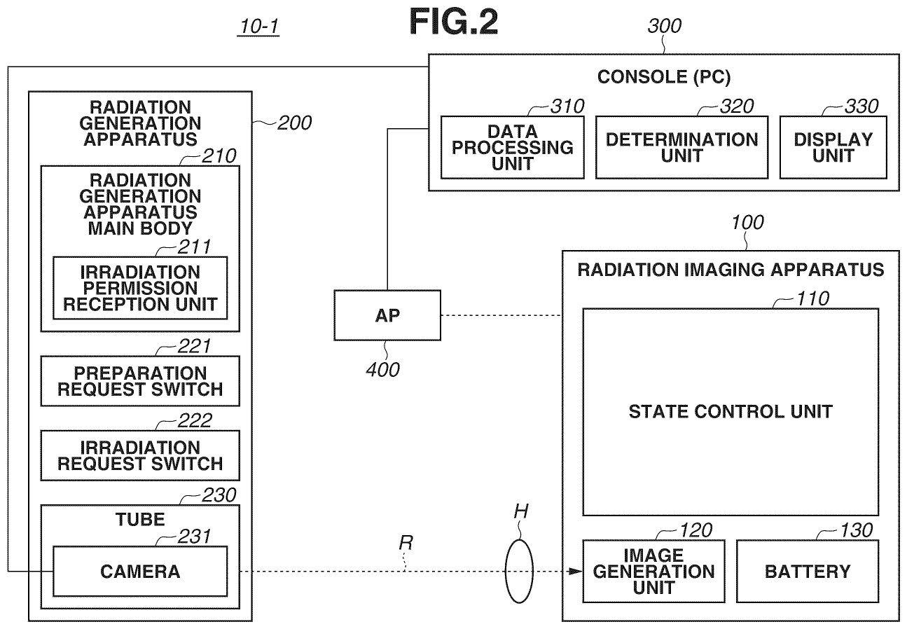

FIG. 2 illustrates examples of internal functional configurations of the radiation imaging apparatus 100, the radiation generation apparatus 200, and the console 300 in FIG. 1 in the radiation imaging system 10-1 according to the first exemplary embodiment of the present disclosure. In FIG. 2, components similar to those in FIG. 1 are assigned the same reference numerals, and detailed descriptions thereof will be omitted.

FIG. 2 illustrates the radiation imaging system 10-1 that performs the radiation imaging on a subject H. In this case, the subject H is disposed at a position between the radiation generation apparatus 200 (more specifically, the tube 230 of the radiation generation apparatus 200) and the radiation imaging apparatus 100 (more specifically, an image generation unit 120 of the radiation imaging apparatus 100). According to the present exemplary embodiment, the subject H is, for example, a patient.

The radiation generation apparatus main body 210 of the radiation generation apparatus 200 controls the operation of the radiation generation apparatus 200 in a centralized manner. The radiation generation apparatus main body 210 includes an irradiation permission reception unit 211 for receiving information about a permission for the radiation R irradiation.

When the preparation request switch 221 is pressed by an operator who will perform the radiation imaging, the radiation generation apparatus 200 performs the radiation R irradiation preparation. When the irradiation request switch 222 is pressed by, for example, the operator who performs the radiation imaging, the radiation generation apparatus 200 performs the radiation R irradiation from the tube 230. For example, even in a case where the irradiation request switch 222 is pressed, the radiation generation apparatus 200 does not perform the radiation R irradiation until the radiation R irradiation preparation triggered by the depression of the preparation request switch 221 is completed. In response to completion of the radiation R irradiation preparation, the radiation generation apparatus 200 performs the radiation R irradiation. The preparation request switch 221 and the irradiation request switch 222 are often integrally formed as a two-step switch.

The tube 230 of the radiation generation apparatus 200 is disposed at a position facing the image generation unit 120 of the radiation imaging apparatus 100 so that the subject H serving as an imaging target is sandwiched between the tube 230 and the image generation unit 120 of the radiation imaging apparatus 100. In this case, the radiation imaging apparatus 100 is disposed in correspondence to the position and posture of the subject H and the imaging portion of the subject H. Thus, the tube 230 can be freely moved to a certain extent to face the radiation imaging apparatus 100 (more specifically, the image generation unit 120). In the visiting car K to which the radiation imaging system 10-1 is applied, the radiation generation apparatus 200 is moved before use, so that the tube 230 is compactly stored in the visiting car K when not in use. At the time of imaging, the tube 230 is drawn from the storage and the imaging preparation is performed. According to the present exemplary embodiment, the tube 230 of the radiation generation apparatus 200 is a radiation irradiation unit for performing the radiation R irradiation toward the subject H and the radiation imaging apparatus 100 (more specifically, the image generation unit 120 of the radiation imaging apparatus 100). The tube 230 serving as a radiation irradiation unit includes a camera 231 for capturing the subject H and the radiation imaging apparatus 100. The camera 231 moves in association with the movement of the tube 230 and captures the subject H and the radiation imaging apparatus 100. Image data of a camera image captured by the camera 231 is transmitted to the console 300. In this case, the camera 231 and the console 300 may be connected via a wire cable, such as a Local Area Network (LAN) cable or a Universal Serial Bus (USB) cable, or via wireless communication, such as a Wireless Local Area Network (WLAN) or Bluetooth®.

As illustrated in FIG. 2, the radiation imaging apparatus 100 includes a state control unit 110, the image generation unit 120, and a battery 130. In the radiation imaging apparatus 100, the state control unit 110 switches between a wait state and an imaging-ready state. The wait state provides a lower power consumption than the imaging-ready state.

The image generation unit 120 that serves as an image generation unit generates a radiation image based on incident radiation R (including radiation R having penetrated the subject H).

The battery 130 is an internal power supply unit for enabling the operation of the radiation imaging apparatus 100 even if the radiation imaging apparatus 100 is not supplied with external power supply. The battery 130 is often a battery that is reusable through charging. Such batteries are represented by lithium-ion batteries. The battery 130 may be built in the radiation imaging apparatus 100 (undetachable from the radiation imaging apparatus 100) or detachable from the radiation imaging apparatus 100. The battery 130 may be charged by a charger for charging the battery 130 in a state of being detached from the radiation imaging apparatus 100 or charged by another power source in a state of being built in the radiation imaging apparatus 100.

The radiation imaging apparatus 100 operates on power supplied from the battery 130. However, if the residual quantity of the battery 130 runs out, the battery 130 is to be replaced with another one or charged by another power source, resulting in downtime or limitations on use. Thus, desirably, the power consumption of the radiation imaging apparatus is as small as possible. To reduce the power consumption of the radiation imaging apparatus 100, it is also effective to prolong the time duration of a low power consumption. Thus, the state control unit 110 of the radiation imaging apparatus 100 performs control to reduce the time duration of the imaging-ready state as much as possible to prolong the wait state.

As illustrated in FIG. 2, the console 300 includes a data processing unit 310, a determination unit 320, and a display unit 330.

The data processing unit 310 processes image data on a camera image received from the camera 231 and image data on a radiation image received from the radiation imaging apparatus 100. The data processing unit 310 subjects image data to various processing, such as correction processing, noise reduction processing, filtering, emphasis processing, image conversion and deformation, and feature quantity extraction and calculation.

The determination unit 320 determines whether a condition related to the execution of the radiation imaging of the subject H becomes a predetermined state by using a predetermined criterion for the image data on the camera image processed by the data processing unit 310. According to the present exemplary embodiment, the condition related to the execution of the radiation imaging of the subject H includes at least any one of the positional relation between the radiation generation apparatus 200 and the radiation imaging apparatus 100, the positional relation between the subject H and the radiation imaging apparatus 100, or the posture of the subject H. More specifically, as the positional relation between the radiation generation apparatus 200 and the radiation imaging apparatus 100, the positional relation between the tube 230, serving as radiation irradiation unit, of the radiation generation apparatus 200 and the image generation unit 120 of the radiation imaging apparatus 100 is desirably applied. As the positional relation between the subject H and the radiation imaging apparatus 100, the positional relation between the subject H and the image generation unit 120 of the radiation imaging apparatus 100 is desirably applied. A result of determination as to whether the condition related to the execution of the radiation imaging of the subject H made by the determination unit 320 is transmitted to the radiation imaging apparatus 100 connected with a wireless LAN, via the wireless access point 400. If the determination unit 320 determines that the above-described condition related to the execution of the radiation imaging of the subject H becomes a predetermined state, the state control unit 110 of the radiation imaging apparatus 100 performs controls to transition the state of the radiation imaging apparatus 100 from the wait state to the imaging-ready state.

The display unit 330 serves as a display unit that displays various types of information and images to the operator who performs the radiation imaging.

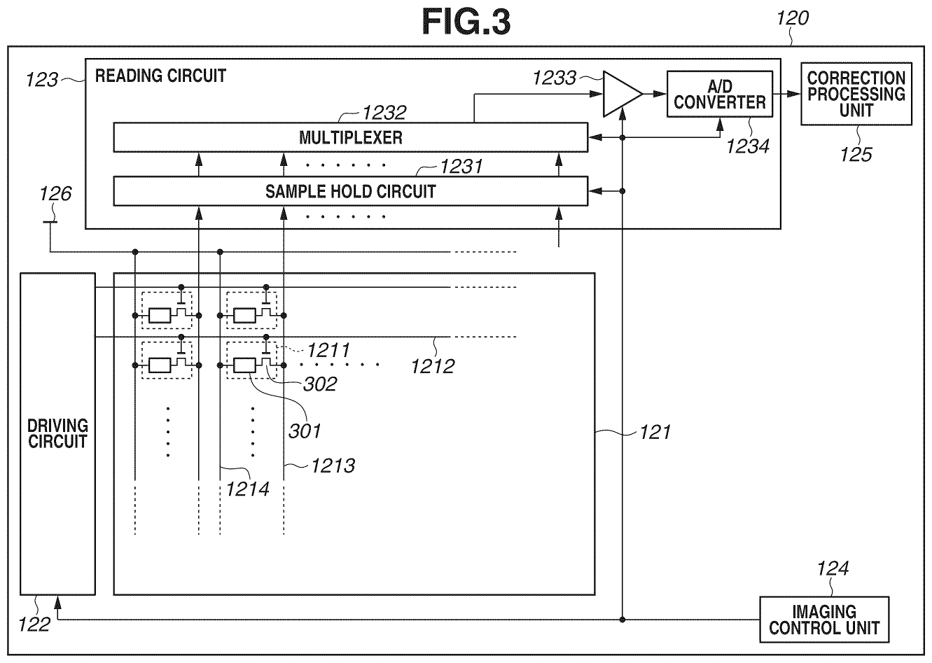

FIG. 3 illustrates an example of the internal configuration of the image generation unit 120 illustrated in FIG. 2 according to the first exemplary embodiment of the present disclosure. As illustrated in FIG. 3, the image generation unit 120 includes a radiation detection unit 121, a driving circuit 122, a reading circuit 123, an imaging control unit 124, a correction processing unit 125, and a power source unit 126.

The radiation detection unit 121 includes a plurality of pixels 1211 disposed in a two-dimensional array form to configure a plurality of rows and a plurality of columns. Each of the plurality of pixel 1211 includes a conversion element 301 and a switching element 302.

The conversion element 301 converts the incident radiation R into charges as an electrical signal and accumulates the charges. The conversion element 301 may include a scintillator for converting radiation R into visible light and a photoelectric conversion element for converting visible light generated by the scintillator into charges. The conversion element 301 may directly convert the radiation R into charges. One terminal of the conversion element 301 is supplied with a bias voltage from the power source unit 126 via a bias line 1214. The other terminal of the conversion element 301 is connected to a signal line 1213 via the switching element 302.

The switching element 302 transfers charges accumulated in the conversion element 301 to the signal line 1213. The switching element 302 includes, for example, a transistor such as a Thin-Film Transistor (TFT). The switching element 302 has a control terminal. If the control terminal is supplied with an ON voltage, the switching element 302 turns ON, specifically, shifts into a conducting state. If the control terminal is supplied with the OFF voltage, the switching element 302 turns OFF (non-conducting state). The control terminal of the switching element 302 is connected to a drive line 1212 connected to the driving circuit 122. The radiation detection unit 121 includes a plurality of the drive lines 1212 each extending in the row direction (horizontal direction in FIG. 3), arranged in the column direction (vertical direction in FIG. 3). Each of the drive lines 1212 is commonly connected to the control terminals of the switching elements 302 of the pixels 1211 included in the same row. The radiation detection unit 121 includes a plurality of the signal lines 1213 each extending in the column direction, arranged in the row direction. Each of the signal lines 1213 is commonly connected to one main terminals of the switching elements 302 of the pixels 1211 included in the same column.

The driving circuit 122 drives the radiation detection unit 121 according to a control signal supplied from the imaging control unit 124. More specifically, the driving circuit 122 supplies a drive signal to the control terminal of each switching element 302 via the drive line 1212. The driving circuit 122 turns ON the switching element 302 by supplying the ON voltage of the drive signal, and turns OFF the switching element 302 by supplying the OFF voltage of the drive signal. When the switching element 302 turns ON, charges accumulated in the conversion element 301 are transferred to the signal line 1213.

The reading circuit 123 reads charges from the radiation detection unit 121 according to the control signal supplied from the imaging control unit 124, and generates a signal according to the charges. The reading circuit 123 supplies the generated signal to the correction processing unit 125. As illustrated in FIG. 3, the reading circuit 123 includes a sample hold circuit 1231, a multiplexer 1232, an amplifier 1233, and an analog-to-digital (A/D) converter 1234. The sample hold circuit 1231 holds charges read from the conversion element 301 in pixel row units. The multiplexer 1232 sequentially takes out charges of pixels for one row held by the sample hold circuit 1231 and supplies the charges to the amplifier 1233. The amplifier 1233 amplifies the charges supplied from the multiplexer 1232 and supplies the charges as an analog signal to the A/D converter 1234. The A/D converter 1234 converts the analog signal supplied from the amplifier 1233 into a digital signal (equivalent to the above-described image data on the radiation image) and supplies the digital signal to the correction processing unit 125.

The imaging control unit 124 controls the operation of the image generation unit 120 in a centralized manner.

The correction processing unit 125 subjects the image data on the radiation image converted into a digital signal, for example, to dark correction to obtain the image data on the captured image with unnecessary dark charge components reduced. More specifically, in the dark correction, the correction processing unit 125 subtracts the image data on a dark image acquired only from dark charge components without the radiation R irradiation from the image data on the radiation image converted into a digital signal. According to the present exemplary embodiment, the image data on the captured image is simply regarded as the image data on the radiation image.

The power source unit 126 supplies each main operation voltage, such as the bias voltage, and operates on external power supply or power supplied from the battery 130. For example, the power source unit 126 supplies the bias voltage to the conversion element 301 of the radiation detection unit 121 via the bias line 1214.

The present exemplary embodiment is intended for a case where the radiation imaging apparatus 100 itself detects the start of the radiation R irradiation and operates in an imaging mode in which the radiation imaging apparatus 100 transitions to a charge accumulation state. Examples of methods for detecting the start of the radiation R irradiation include a method for detecting the radiation R irradiation by using a dedicated sensor and a method for detecting the radiation R irradiation by using the image generation unit 120. The detection method is not limited thereto. The present exemplary embodiment employs a method for detecting the start of the radiation R irradiation by measuring changes of the current generated by the radiation R irradiation while continuing the operation for reading charges from the radiation detection unit 121 to the reading circuit 123 by sequentially turning the switching elements 302 ON or OFF. According to the present exemplary embodiment, a state where the image generation unit 120 can detect the start of the radiation R irradiation is regarded as an imaging-ready state.

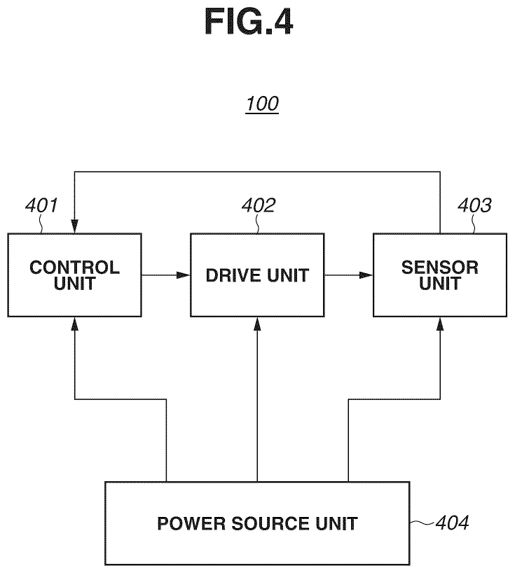

FIG. 4 illustrates an example of a functional configuration of the radiation imaging apparatus 100 illustrated in FIGS. 2 and 3.

As illustrated in FIG. 4, the radiation imaging apparatus 100 has functional configurations including a control unit 401, a drive unit 402, a sensor unit 403, and a power source unit 404.

The control unit 401 includes, for example, the state control unit 110 illustrated in FIG. 2, and the imaging control unit 124 and the correction processing unit 125 illustrated in FIG. 3. The drive unit 402, for example, includes the driving circuit 122 illustrated in FIG. 3. The sensor unit 403 includes, for example, the radiation detection unit 121 and the reading circuit 123 illustrated in FIG. 3. The power source unit 404 includes, for example, the battery 130 illustrated in FIG. 2 and the power source unit 126 illustrated in FIG. 3.

The control unit 401 is a component for controlling the drive unit 402 and communicating with the outside. For example, the control unit 401 can include a CPU, memories, such as a flash memory and a Dynamic Random Access Memory (DRAM), serving as peripheral circuits, and wired and wireless communication interfaces. The drive unit 402 may include programmable logic circuits, such as a Field Programmable Gate Array (FPGA) and a Complex Programmable Logic Device (CPLD). The power source unit 404 may separately supply power to the control unit 401, the drive unit 402, and the sensor unit 403. Although the control unit 401 and the drive unit 402 are functionally separated, the two units do not need to be separate devices but may be configured as one device such as an Application Specific Integrated Circuit (ASIC) including a CPU and logic circuits in the same package, or a FPGA including a CPU. Even in this case, desirably, the control unit 401 and the drive unit 402 are configured to be separately supplied with power.

According to the present disclosure, the wait state of the radiation imaging apparatus 100 provides a lower power consumption than in the imaging-ready state. More specifically, the wait state refers to a state where power is turned off for each functional component in FIG. 4. For example, in the wait state of the radiation imaging apparatus 100, the control unit 401 is still operating to control the radiation imaging apparatus 100. In this state, however, at least either one of the powers of the drive unit 402 or the sensor unit 403 used only for the imaging operation may be turned off. For example, the wait state of the radiation imaging apparatus 100 may be a state where the drive unit 402 and/or the sensor unit 403 are maintained reset or not driven while being supplied with power. For example, to minimize the power consumption in the wait state of the radiation imaging apparatus 100, only a state communicable with the console 300 is maintained, and the CPU of the control unit 401 is activated only in response to reception of a trigger such as an interrupt from an external operation.

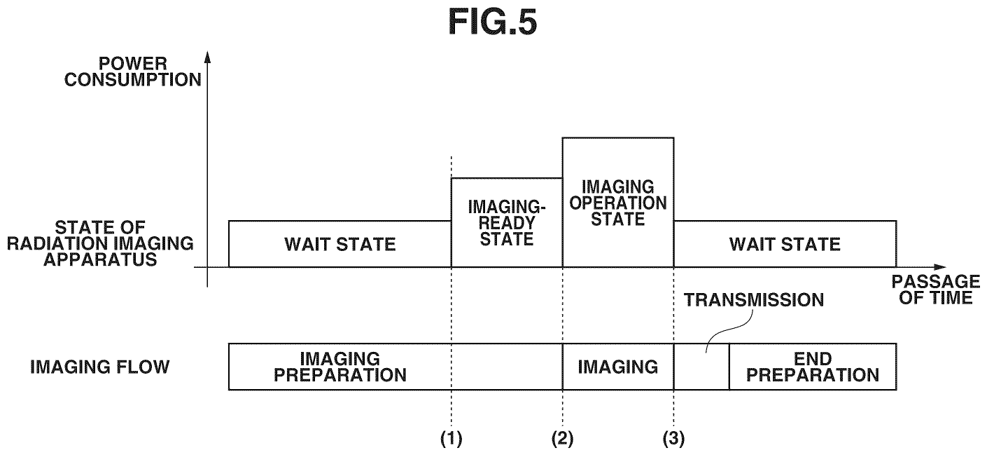

FIG. 5 illustrates relations between the state and power consumption of the radiation imaging apparatus 100 and the elapsed time, and an example of an imaging processing flow of the radiation imaging apparatus 100 according to the first exemplary embodiment of the present disclosure. In an area in FIG. 5 illustrating the relations between the state and power consumption of the radiation imaging apparatus 100 and the elapsed time, the state of the radiation imaging apparatus 100 is described in each block. The horizontal axis denotes the passage of time and the vertical axis denotes the magnitude of the power consumption. As illustrated in FIG. 5, the radiation imaging apparatus 100 in the wait state provides a lower power consumption than the imaging-ready state. On the contrary, the radiation imaging apparatus 100 in the imaging-ready state provides a larger power consumption than the wait state. In an area in FIG. 5 indicating an imaging processing of the radiation imaging apparatus 100, the relation between the state of the radiation imaging apparatus 100 and the imaging processing of the radiation imaging apparatus 100 is illustrated.

In a case where the radiation imaging is performed in the visiting car K, an operator, such as a technician of the radiation imaging, once moves, together with the visiting car 5, to the bedside of the subject H and then starts the imaging preparation.

In this imaging preparation period, the radiation imaging apparatus 100 is in the wait state. Then, the operator checks a subject H, an imaging portion, imaging conditions based on an imaging order received in advance. Then, the operator sets the radiation imaging apparatus 100 to satisfy the imaging position of the subject H and the imaging conditions, and adjusts the posture of the subject H. The operator moves the tube 230 of the radiation generation apparatus 200 to adjust the position of the tube 230 so that the tube 230 faces the subject H and the radiation imaging apparatus 100. At this timing, the operator performs adjustment so that the relative positional relation between the tube 230 of the radiation generation apparatus 200 and the radiation imaging apparatus 100 becomes a state suitable for performing the radiation imaging. The state suitable for performing the radiation imaging refers to, for example, a state in which a distance between the tube 230 and the radiation imaging apparatus 100 is a predetermined distance. The state suitable for performing the radiation imaging also refers to, for example, a state in which an angle at which the radiation R is vertically incident, or a state in which the radiation R radiated from the tube 230 is radiated to a region intended by the radiation imaging apparatus 100. In particular, an oblique incident angle of the radiation R may cause image degradation. A camera 231 attached to the tube 230 of the radiation generation apparatus 200 captures the radiation imaging apparatus 100 in the imaging preparation period. The method for analyzing the above-described distance, angle, and positional relation based on the camera image captured by the camera 231 may include various executable methods. As an example, imaging with markers disposed at the four corners of the radiation imaging apparatus 100 is performed, image processing is performed, and then the above-descried determination is made. In this case, for example, the shapes and sizes of the four markers and the distances between the markers in the captured image are extracted through the image processing, and whether predetermined conditions are met is determined. The shapes and the number of markers do not matter as long as the desired detection and determination can be performed. Such processing may be executed by a processor such as a CPU or hardware circuitry such as an ASIC and a FPGA, or may be configured to be separately executed. Such processing is performed in the console 300 (the data processing unit 310 and the determination unit 320).

Assume a case where, after the above-described processing, the determination unit 320 of the console 300 determines that the positional relation between the tube 230 of the radiation generation apparatus 200 and the radiation imaging apparatus 100 becomes a predetermined state in the radiation imaging. In this case, the radiation imaging is presumably to be performed after a short time, so that the state control unit 110 of the radiation imaging apparatus 100 performs control so that the state of the radiation imaging apparatus 100 is transitioned from the wait state to the imaging-ready state, with a result of the determination made by the determination unit 320 acting as a trigger. This timing is equivalent to timing (1) in FIG. 5. According to the present exemplary embodiment, the determination unit 320 may perform the determination in consideration of the positional relation between the subject H and the radiation imaging apparatus 100 and/or the posture of the subject H, instead of or in addition to the above-described positional relation between the tube 230 of the radiation generation apparatus 200 and the radiation imaging apparatus 100. Based on the image data on camera images of the subject H and the radiation imaging apparatus 100 captured by the camera 231, the determination unit 320 can determine whether the imaging portion of the subject H and the procedure specified by the imaging order conform to the posture of the subject H. Based on the image data on the camera image of the subject H and the radiation imaging apparatus 100 captured by the camera 231, the determination unit 320 can determine whether the imaging portion of the subject H fits into the imaging region of the radiation imaging apparatus 100. This enables the determination unit 320 to determine whether at least either one of the conditions including the positional relation between the radiation generation apparatus 200 and the radiation imaging apparatus 100, the positional relation between the subject H and the radiation imaging apparatus 100, or the posture of the subject H becomes a predetermined state in the radiation imaging. If at least either one of the above-described conditions becomes a predetermined state as a result of the determination made by the determination unit 320, the state control unit 110 of the radiation imaging apparatus 100 performs control so that the state of the radiation imaging apparatus 100 is transitioned from the wait state to the imaging-ready state.

In response to completion of the imaging preparation, the operator presses the preparation request switch 221 and the irradiation request switch 222 in this order to start the radiation R irradiation from the tube 230 of the radiation generation apparatus 200 toward the subject H and the radiation imaging apparatus 100 (image generation unit 120). This timing is equivalent to timing (2) in FIG. 5. When the radiation imaging apparatus 100 detects the start of the radiation R irradiation, the radiation imaging apparatus 100 performs the operation for capturing a radiation image of the subject H (imaging operation state).

In response to completion of capturing a radiation image of the subject H, the radiation imaging apparatus 100 starts the transmission (transfer) of the image data on the radiation image to the console 300. This timing is equivalent to timing (3) in FIG. 5. The radiation imaging apparatus 100 does not need to be in the imaging-ready state (imaging operation state) during transmission of the image data on a radiation image. Thus, in this time duration, the state control unit 110 of the radiation imaging apparatus 100 performs control so that the radiation imaging apparatus 100 makes a state transition from the imaging-ready state (imaging operation state) to the wait state, for power saving. When using an FPGA as an off-loader for image data transfer, the state control unit 110 may performs control so that the radiation imaging apparatus 100 makes a transition from the imaging-ready state to the wait state through a plurality of stages, for example, by turning power of drive-related circuits OFF at the end of imaging and then turning power of the FPGA OFF at the end of transfer.

According to the present exemplary embodiment, after the state control unit 110 of the radiation imaging apparatus 100 performs control so that the radiation imaging apparatus 100 to make a transition to the imaging-ready state, in a case where the image generation unit 120 reads charges (electrical signal) related to the radiation image, the state control unit 110 may perform control so that the radiation imaging apparatus 100 makes a transition to the wait state.

The console 300 subjects the image data on the received radiation image to necessary image processing, and then displays the image data on the display unit 330 to allow the operator to confirm the radiation image.

After the operator checks the radiation image displayed on the display unit 330 and finds no issues, the radiation imaging apparatus 100 completes the imaging processing flow. The radiation imaging apparatus 100 may transmit the image data on the radiation image not having undergone the correction processing to the console 300 or subject the image data to the internal correction processing. Examples of the internal correction processing include correction processing for reducing dark current components of the image data on the radiation image, processing for correcting the in-plane distribution uniformity of the sensitivity of the radiation detection unit 121, and processing for reducing other noise components. Generally, the personal computer used for the console 300 have higher throughput than that of the processor in the radiation imaging apparatus 100. Therefore, the radiation imaging apparatus 100 performs only low-load processing in a certain form.

After the state of the radiation imaging apparatus 100 is transitioned from the wait state to the imaging-ready state at timing (1) in FIG. 5, the radiation imaging apparatus 100 may possibly deviate from a predetermined state suitable for radiation imaging before performing the radiation imaging. Possible causes of the above-described state include a case where the subject H moves, and the positional relation between the subject H and the radiation imaging apparatus 100 (image generation unit 120) deviates from a predetermined state. If a condition related to the execution of the radiation imaging deviates from a predetermined state in this way, the state control unit 110 of the radiation imaging apparatus 100 cannot execute suitable radiation imaging, and hence performs control so that the state of the radiation imaging apparatus 100 is transitioned from the imaging-ready state to the wait state. Desirably, if a condition related to the execution of the radiation imaging deviates from a predetermined state, the radiation imaging apparatus 100 notifies the operator of the state to allow the operator to notice the state. For example, if a condition related to the execution of the radiation imaging deviates from a predetermined state, the state control unit 110 of the radiation imaging apparatus 100 performs control so that the state is displayed on the display unit 330 of the console 300. In this case, the display unit 330 configures a notification unit for notifying the operator of information. According to the present exemplary embodiment, the notification unit is not limited to the display unit 330 but includes a form for audibly output a notification from an audio output unit (not illustrated) on the console 300. According to the present exemplary embodiment, the above-described notification unit is not limited to being provided only on the console 300 but may be provided on the radiation imaging apparatus 100 or the radiation generation apparatus 200 instead of or in addition to the console 300. The above-described notification unit notifies the operator that the radiation imaging apparatus 100 enters or is in a predetermined state suitable for the imaging, and that the radiation imaging apparatus 100 deviates from or is out of a predetermined state suitable for the imaging.

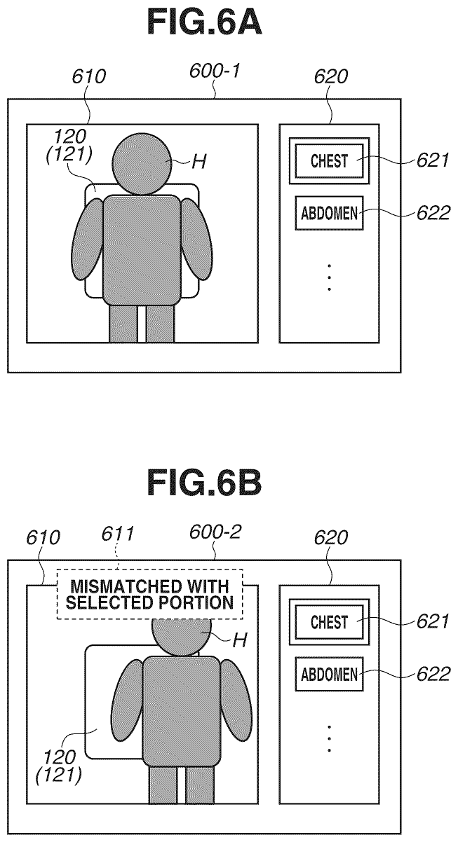

FIGS. 6A and 6B illustrate an example of a display screen 600 displayed on the display unit 330 illustrated in FIG. 2 according to a first exemplary embodiment of the present disclosure. Referring to FIGS. 6A and 6B, components similar to those illustrated in FIGS. 2 and 3 are assigned the same reference numerals, and detailed descriptions thereof will be omitted.

A display screen 600-1 illustrated in FIG. 6A includes a display area 610 for displaying a camera image captured by the camera 231, and an imaging portion display area 620 for selecting an imaging portion. In the display area 610, the subject H and the image generation unit 120 (radiation detection unit 121) captured by the camera 231 are depicted. In the imaging portion display area 620, a chest 621 and an abdominal 622 are depicted. More specifically, a display screen 600-1 in FIG. 6A indicates that the chest 621 is selected as an imaging portion. The display screen 600-1 in FIG. 6A indicates a case where the positional relation between the subject H and the image generation unit 120 depicted in the display area 610 is a predetermined state suitable for capturing the chest 621 of the subject H.

A display screen 600-2 illustrated in FIG. 6B indicates a case where the positional relation between the subject H and the image generation unit 120 in the display area 610 deviates from a predetermined state suitable for capturing the chest 621 of the subject H. Thus, the display screen 600-2 in FIG. 6B displays warning display information 611 for notifying the operator that the state of the radiation imaging apparatus 100 is not suitable for capturing the chest 621 of the subject H.

The radiation imaging apparatus 100 recognizes the matching between the posture of the subject H and the imaging portion specified by the imaging order through image processing, and displays the posture of the subject H in the display screen 600 on the display unit 330 of the console 300, allowing the operator to check the posture of the subject H. However, even if the posture of the subject H is displayed on the display unit 330, the operator may possibly perform the radiation imaging without noticing the display. Thus, the radiation imaging apparatus 100 may be configured to maintain the imaging-ready state to avoid invalid exposure in which the radiation imaging cannot be performed although the subject H is irradiated with the radiation R.

In the above-described case, the state control unit 110 determines whether the radiation imaging apparatus 100 is in a predetermined state suitable for the imaging, by using the camera image captured by the camera 231, and controls the transition of the radiation imaging apparatus 100. In this case, the predetermined state suitable for the imaging may be determined based on the above-described imaging order. However, the present exemplary embodiment is not limited to a form with use of camera images captured by the camera 231. Examples of applicable forms include a form with use of data output from a detection sensor for detecting at least either the position or the movement instead of or in addition to a camera image captured by the camera 231. In this case, examples of applicable detection sensors include at least any one of an acceleration sensor, a gyro sensor, or an earth magnetism sensor. According to this form, a detection sensor is attached to each of the tube 230 of the radiation generation apparatus 200 and the radiation imaging apparatus 100. According to this form, based on the output data from these detection sensors, the state control unit 110 can determine whether a condition related to the execution of the radiation imaging including the relative positional relation between the tube 230 and the radiation imaging apparatus 100 becomes a predetermined state suitable for the imaging. The determination method is not limited to the above-described detection sensors as long as the relative positional relation can be acquired. The camera 231 and the detection sensors may be combined so that the state control unit 110 may determine the positional relation between the tube 230 of the radiation generation apparatus 200 and radiation imaging apparatus 100, the positional relation between the subject H and the radiation imaging apparatus 100, and the posture of the subject H. In this case, the state control unit 110 can perform control so that the radiation imaging apparatus 100 makes a transition from the wait state to the imaging-ready state, by using a result of the determination that a condition related to the execution of the radiation imaging becomes a predetermined state made by the determination unit 320 based on the output data from the detection sensors. Further, the state control unit 110 can perform control so that the radiation imaging apparatus 100 makes a transition from the wait state to the imaging-ready state, by using a result of the determination made by the determination unit 320 based on the camera image captured by the camera 231 and the output data from the detection sensors.

Although, according to the present exemplary embodiment, a camera image captured by the camera 231 and output data from the detection sensors are processed by the console 300, the processing unit is not limited to the console 300 as long as the unit is capable of receiving and processing data. For example, the tube 230 of the radiation generation apparatus 200 may include a unit having the function, or the radiation imaging apparatus 100 may include a processor and/or a hardware component that processes data transmitted to the radiation imaging apparatus 100.

A threshold value used for the state control unit 110 to determine a predetermined state suitable for the imaging and make a transition from the wait state to the imaging-ready state, and a threshold value used for the state control unit 110 to determine a predetermined state not suitable for the imaging and make a transition from the imaging-ready state to the wait state may be the same value or different values with hysteresis. There may be prepared a plurality of threshold values to allow the user to select preferred threshold values according to each individual system. For example, in a case where the radiation imaging apparatus 100 takes time to make a transition from the wait state to the imaging-ready state, the radiation imaging apparatus 100 is to start the transition from the wait state at a certain timing before the radiation R irradiation. In such a case, the threshold values are loosely set so that the usability is maintained.

As discussed above, in a case where a condition related to the execution of the radiation imaging becomes a predetermined state, the state control unit 110 of the radiation imaging apparatus 100 according to the first exemplary embodiment performs control so that the radiation imaging apparatus 100 makes a transition from the wait state in which a lower power consumption is provided than in the imaging-ready state) to the imaging-ready state.

The above-described configuration makes it possible to perform suitable radiation imaging while maintaining power saving.

Thus, the radiation imaging apparatus 100 can perform the radiation imaging without degradation in the operator's usability.

A second exemplary embodiment will be described below. In the following descriptions of the second exemplary embodiment, descriptions of elements common to the above-described first exemplary embodiment will be omitted, and only elements different from the first exemplary embodiment will be described below.

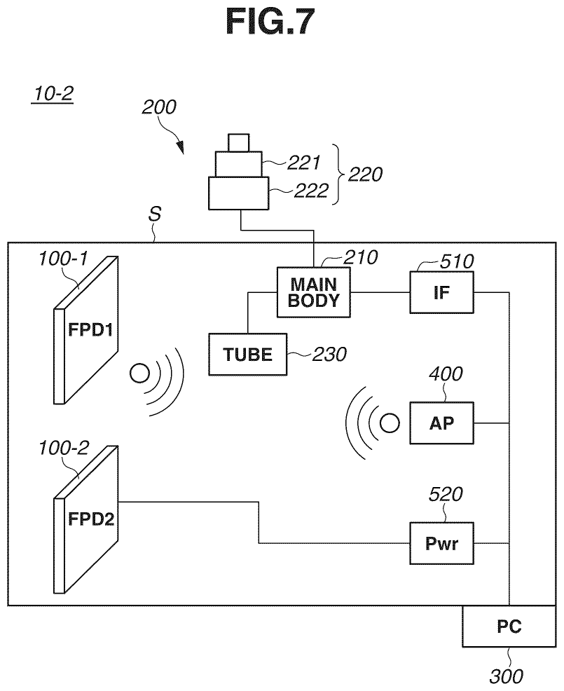

FIG. 7 illustrates an example of an overall configuration of a radiation imaging system 10-2 according to the second exemplary embodiment of the present disclosure. Referring to FIG. 7, components similar to those illustrated in FIG. 1 are assigned the same reference numerals, and detailed descriptions thereof will be omitted. The radiation imaging system 10-2 is installed, for example, in a radiographing room S.

Radiation imaging apparatuses 100-1 and 100-2 are disposed in the radiographing room S. The radiation imaging apparatuses 100-1 and 100-2 can operate on a battery or external power supply as in the radiation imaging apparatus 100 according to the first exemplary embodiment.

In the radiographing room S, the wireless access point 400 and the console 300 for controlling the radiation imaging apparatuses 100-1 and 100-2 are disposed in addition to the radiation imaging apparatuses 100-1 and 100-2. In the radiographing room S, the radiation generation apparatus main body 210, the radiation switch 220, and the tube 230 are disposed as the radiation generation apparatus 200. Further, in the radiographing room S, a power supply unit 520 (referred to as “Pwr” in FIG. 7) and a generation apparatus I/F unit 510 (referred to as an “IF” in FIG. 7) for adjusting the timing between the radiation imaging apparatuses 100-1 and 100-2 and the radiation generation apparatus main body 210 are disposed. The power supply unit 520 is an apparatus for supplying power to the radiation imaging apparatus 100 (e.g., the radiation imaging apparatus 100-2 in FIG. 7). The power supply unit 520 not only supplies power to the radiation imaging apparatus 100 but also relays communication between the radiation imaging apparatus 100 (e.g., the radiation imaging apparatus 100-2 in FIG. 7) and each communication apparatus via a wired communication interface. The radiation imaging apparatus 100-1 operates on a battery, wirelessly communicates with the wireless access point 400, and transmits a radiation image to the console 300. The radiation imaging apparatus 100-2 is connected to the power supply unit 520 and operates on external power supply to perform wired communication.

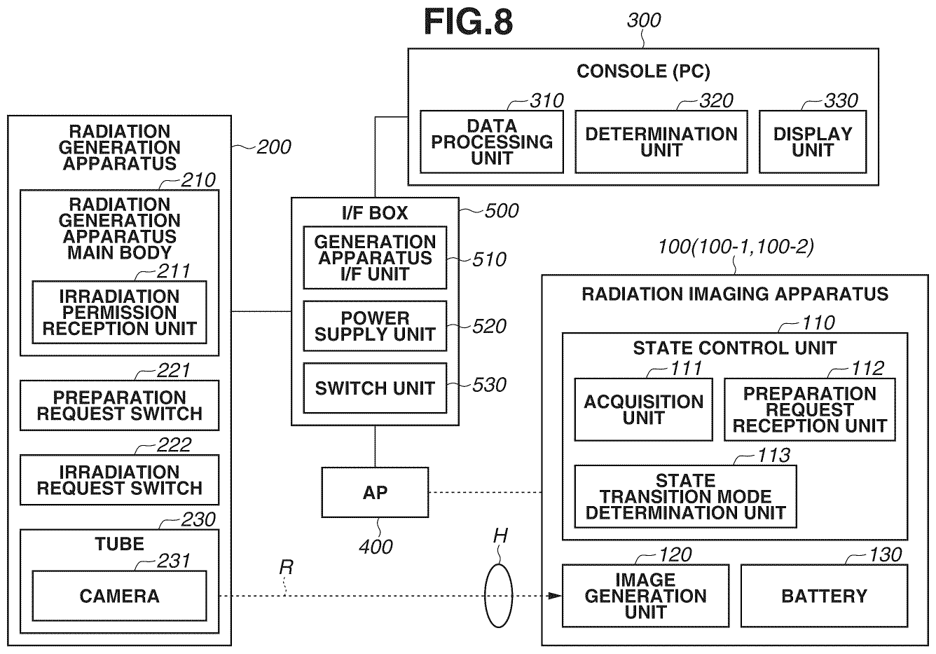

FIG. 8 illustrates examples of internal functional configurations of the radiation imaging apparatuses 100-1 and 100-2, the radiation generation apparatus 200, and the console 300 illustrated in FIG. 7, and the I/F box 500 in the radiation imaging system 10-2 according to the second exemplary embodiment of the present disclosure. In FIG. 8, components similar to those illustrated in FIG. 7 are assigned the same reference numerals, and detailed descriptions thereof will be omitted.

The I/F box 500 illustrated in FIG. 8 includes a switch unit 530 in addition to the generation apparatus I/F unit 510 and the power supply unit 520 illustrated in FIG. 7. For example, the switch unit 530 has a function of switching Ethernet communication for each apparatus.

Referring to the example in FIG. 8, the radiation imaging apparatuses 100-1 and 100-2 and the I/F box 500 are connected to each other via the wireless access point 400. The radiation imaging apparatuses 100-1 and 100-2 can be supplied with power from the I/F box 500 through wired communication via a cable. A dedicated cable with an Ethernet communication cable and a power supply cable bundled together is easy to handle.

When the preparation request switch 221 is pressed, the radiation generation apparatus 200 transmits information about an irradiation preparation start request to the radiation imaging apparatus 100-1. When the irradiation request switch 222 is pressed, the radiation generation apparatus 200 transmits information about an irradiation request to the radiation imaging apparatuses 100-1 and 100-2. When the radiation generation apparatus main body 210 receives, via the irradiation permission reception unit 211, the information about the permission for the radiation R irradiation in the state ready for the radiation R irradiation, the radiation generation apparatus main body 210 performs the radiation R irradiation from the tube 230. As in the first exemplary embodiment, the tube 230 is attached with the camera 231. In this case, the camera 231 is connected to the console 300 via the switch unit 530 of the I/F box 500 through Ethernet.

The console 300 processes the image data on the camera image of the camera 231 received via the I/F box 500, with the data processing unit 310, and performs a determination similar to that in the first exemplary embodiment via the determination unit 320 based on the result of the processing. The determination unit 320 transmits a determination result to the radiation imaging apparatuses 100-1 and 100-2 via the I/F box 500.

As illustrated in FIG. 8, the radiation imaging apparatuses 100-1 and 100-2 include the state control unit 110, the image generation unit 120, and the battery 130. In the radiation imaging apparatuses 100-1 and 100-2, the state control unit 110 switches between the imaging-ready state and the wait state in which a lower power consumption is provided than in the imaging-ready state, as in the radiation imaging apparatus 100 according to the first exemplary embodiment.

As illustrated in FIG. 8, the state control unit 110 includes an acquisition unit 111, a preparation request reception unit 112 for receiving a radiation preparation request, and a state transition mode determination unit 113. The image generation unit 120 serves as an image generation unit configured to generate a radiation image based on incident radiation R and has a configuration similar to that in FIG. 3.

According to the second exemplary embodiment, the radiation imaging apparatuses 100-1 and 100-2 have different transition modes for the transition from the wait state to the imaging-ready state, and suitably select a mode according to the apparatus characteristics and imaging conditions. The state transition mode determination unit 113 having the function determines the power state of the radiation imaging apparatuses 100-1 and 100-2 to be used as a trigger for the state transition, and reflects the trigger to the operation of the state control unit 110.

A case where the radiation imaging apparatuses 100-1 and 100-2 have two different state transition modes will be described below. In the following descriptions, in a case where the radiation imaging apparatuses 100-1 and 100-2 are not specifically distinguished, the apparatuses 100-1 and 100-2 are simply referred to as a radiation imaging apparatus 100.

In the first state transition mode which is the same as the one according to the first exemplary embodiment, the operator captures the subject H and the radiation imaging apparatus 100 by using the camera 231 attached to the tube 230. In this mode, with the radiation imaging apparatus 100 having entered a predetermined state suitable for the imaging based on the image data on the camera image serving as a trigger, the radiation imaging apparatus 100 is transitioned from the wait state to the imaging-ready state. This mode is referred to as an “imaging preparation completion trigger mode”.

In the second state transition mode, in response to a depression of the preparation request switch 221 of the radiation generation apparatus 200, the radiation imaging apparatus 100 is transitioned from the wait state to the imaging-ready state.

This mode is referred to as a “preparation request switch trigger mode”.

The preparation request switch trigger mode will be described below.

The preparation request reception unit 112 of the radiation imaging apparatus 100 receives information about a radiation preparation request (including information about the start of the radiation R irradiation preparation) from the radiation generation apparatus 200. An accumulation time Ta during which charges resulting from the radiation R emitted by the radiation imaging apparatus 100 are accumulated is set with the console 300 that has received an imaging order from an in-house system or the like. In the radiation imaging apparatus 100, the acquisition unit 111 acquires information about the accumulation time Ta as part of imaging information. The characteristics of the radiation generation apparatus 200 include irradiation preparation time when the radiation generation apparatus 200 makes a transition from the wait state to the state ready for the radiation R irradiation. According to the present exemplary embodiment, time information required for the irradiation preparation of the radiation generation apparatus 200 is referred to as irradiation preparation time Tg. The irradiation preparation time Tg includes the time duration since the time when a rotational state of a rotating anode of the tube 230 becomes stable till the time when an in-plane distribution of radiation R becomes uniform. The irradiation preparation time Tg varies depending on the tube 230 of the radiation generation apparatus 200. The irradiation preparation time Tg of the radiation generation apparatus 200 in the visiting car K as exemplified in the first exemplary embodiment is often longer than the irradiation preparation time Tg of the radiation generation apparatus 200 in the radiographing room S according to the second exemplary embodiment. For example, even if the irradiation request switch 222 is pressed before the irradiation preparation time Tg has elapsed, an irradiation request is not issued, but an irradiation request is issued at the time when the irradiation preparation time Tg has elapsed. The preparation request switch 221 and the irradiation request switch 222 are often integrally formed as a two-step switch. According to the present exemplary embodiment, the above-described radiation irradiation characteristics are calculated based on information about the start of the radiation R irradiation preparation in the radiation generation apparatus 200 and information about the completion of the radiation R irradiation preparation in the radiation generation apparatus 200.

According to the present exemplary embodiment, time information during which the radiation imaging apparatus 100 makes a transition from the wait state to the imaging-ready state is referred to as imaging preparation time Tp. The imaging preparation time Tp includes the time duration since the time when power is supplied to the radiation detection unit 121 till the time when the charge accumulation characteristics become stable and artifacts disappear. Thus, the radiation imaging apparatus 100 does not enter the imaging-ready state immediately after the wait state is canceled but requires a predetermined time duration. As means for quickly stabilizing the charge accumulation characteristics during the state transition, the driving circuit 122 drives the radiation detection unit 121 to continuously discharge dark charge components. In the present exemplary embodiment, preparation drive indicates drive in which the driving circuit 122 is operated together with the reading circuit to distinguish from the drive for reading accumulated charges as the image data on the radiation image and to stabilize the charge accumulation characteristics during the state transition. Generally, the radiation detection unit 121 has such characteristics that performing the preparation drive reduces the imaging preparation time Tp, and increasing the number of preparation drives in unit time shortens the imaging preparation time Tp. During the accumulation time Ta, the radiation detection unit 121 stops the operations of the driving circuit 122 and the reading circuit 123 to turn OFF the above-described switching elements 302 and continues the state in which charges generated by the radiation R irradiation are accumulated. Generally, the longer the accumulation time Ta, the longer the imaging preparation time Tp. According to the present exemplary embodiment, the imaging preparation time Tp is defined as the time duration to be taken to make a transition from the wait state to the imaging-ready state. The imaging preparation time Tp also includes the time duration to be taken to activate the components to be used to start a transition from the wait state before performing the preparation drive. For example, the imaging preparation time Tp includes the recovery time from the suspended mode of the CPU, the power-ON and configuration time and the initialization time of the FPGA, and the time duration since power of the sensors is turned ON until the power becomes stable.

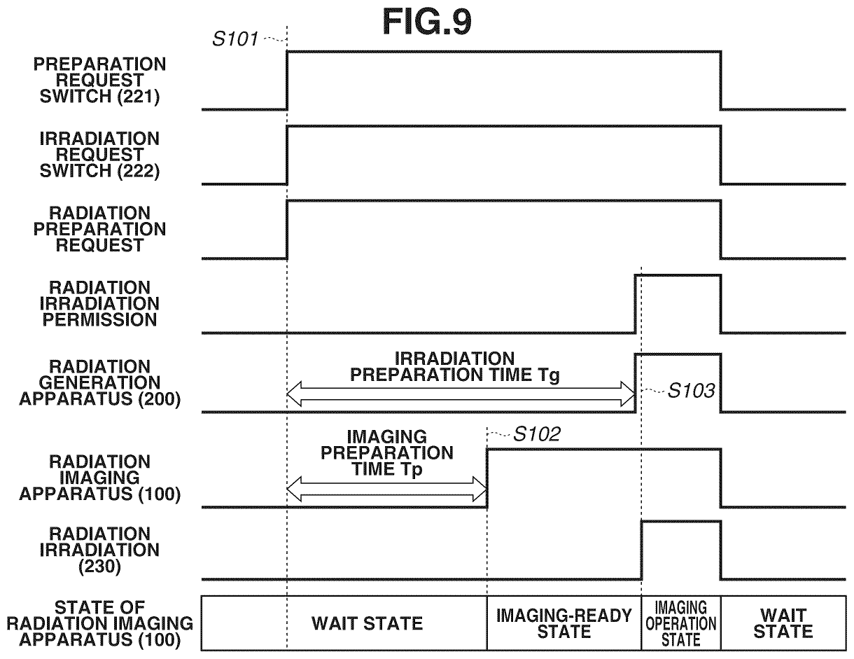

FIG. 9 illustrates examples of drive timings of different apparatuses and states of the radiation imaging apparatus 100 in the radiation imaging system 10-2 according to the second exemplary embodiment of the present disclosure. The operation in the latter mode will be described below with reference to FIG. 9.

The operator checks the details of the imaging based on an imaging order received from the in-house server, on the console 300. At this timing, the required accumulation time Ta is acquired based on imaging conditions in association with the imaging order, and the imaging preparation time Tp of the radiation imaging apparatus 100 according to the accumulation time Ta is calculated. As described above, the imaging preparation time Tp is correlated with the accumulation time Ta. Generally, the longer the accumulation time Ta, the longer the imaging preparation time Tp. This relation is a characteristic specific to the radiation imaging apparatus 100, and can be preset by using catalogue values. From the console 300, the accumulation time Ta is specified as part of the imaging condition information to the radiation imaging apparatus 100 (the radiation imaging apparatus 100-1 in the example in FIG. 7). The radiation imaging apparatus 100 acquires the irradiation preparation time Tg of the radiation generation apparatus 200 from the imaging conditions. As an example of a method for obtaining the irradiation preparation time Tg, time information required for the irradiation preparation of the radiation generation apparatus 200 is preset to the radiation imaging apparatus 100. The irradiation preparation time Tg can be acquired from specification values and design values of the radiation generation apparatus 200, and can be set by an installer when the radiation imaging apparatus 100 is installed. Information for identifying the radiation generation apparatus 200 or the irradiation preparation time information may be included in the protocol and acquired from the console 300. If the radiation generation apparatus 200 has fixed irradiation preparation time Tg under any irradiation conditions, the irradiation preparation time Tg can be determined based on the information for identifying the radiation generation apparatus 200 to be used for the imaging. The radiation imaging apparatus 100 may be configured to acquire the irradiation preparation time Tg by communicating with the radiation generation apparatus 200. The console 300 or a different apparatus may communicate with the radiation generation apparatus 200 to acquire the irradiation preparation time Tg, and then the apparatus that has acquired information may provide the information to the radiation imaging apparatus 100. The radiation imaging apparatus 100 may acquire the irradiation preparation time Tg from the radiation generation apparatus 200. Alternatively, the radiation imaging apparatus 100 may actually perform the radiation R irradiation in a state where the subject H is not placed and measure the irradiation preparation time Tg at this timing. The irradiation preparation time Tg may have certain variations even in the radiation R irradiation under the same condition. If an irradiation condition such as the tube voltage of the tube 230 is changed, the irradiation preparation time Tg may also change. Thus, the irradiation preparation time Tg may be defined based on the average, minimum, and maximum values of measured values and may be set as a different value for each irradiation condition. The radiation imaging apparatus 100 may acquire this information each time it is activated or initialized or when the radiation generation apparatus 200 or a radiation condition is changed. Further, the radiation imaging apparatus 100, the console 300, or a different apparatus may store and manage the information as parameters in association with each model or individual of the radiation generation apparatus 200, imaging procedures, and irradiation conditions.

In this example, the radiation imaging apparatus 100-1 illustrated in FIG. 7 performs the radiation imaging under a condition “Irradiation preparation time Tg≥Imaging preparation time Tp” as illustrated in FIG. 9.

In step S101 in FIG. 9, the operator presses the preparation request switch 221 and the irradiation request switch 222. Accordingly, the radiation generation apparatus 200 prepares for the radiation R irradiation over the irradiation preparation time Tg. Even if the operator presses the irradiation request switch 222 before completion of the irradiation preparation, no radiation irradiation request is issued to the radiation imaging apparatus 100-1. A preparation request issued in response to depression of the preparation request switch 221 is transmitted to the radiation imaging apparatus 100-1 via the I/F box 500 and the wireless access point 400 and then received by the preparation request reception unit 112.

In response to reception of the request, in step S102 in FIG. 9, the radiation imaging apparatus 100-1 starts a transition from the wait state and performs the preparation drive over a required time duration to complete the transition to the imaging-ready state.

In step S103 in FIG. 9 at which the irradiation preparation time Tg has elapsed, the radiation generation apparatus 200 completes the irradiation preparation, and the irradiation permission reception unit 211 receives a radiation irradiation permission issued from the radiation imaging apparatus 100-1. In response to reception of the radiation irradiation permission, the radiation generation apparatus 200 performs the radiation R irradiation from the tube 230, and the radiation imaging apparatus 100-1 transitions to the accumulation state to accumulate charges, reads charges, and completes the imaging operation. Processing for the correction and transmission of the image data on the radiation image is similar to the processing according to the first exemplary embodiment. Processing for controlling the radiation imaging apparatus 100-1 to make a transition to the wait state after the imaging operation is also similar to the processing according to the first exemplary embodiment.

In the imaging mode for controlling the radiation imaging apparatus 100-1 to make a transition to the imaging-ready state with a depression of the preparation request switch 221 of the radiation generation apparatus 200 serving as a trigger, the wait state can be maintained till the timing just before the radiation imaging, producing a remarkable effect on the reduction of the power consumption.

The condition “Irradiation preparation time Tg≥Imaging preparation time Tp” involves wait time due to the radiation generation apparatus 200. With the condition “Irradiation preparation time Tg<Imaging preparation time Tp”, the operator needs to further wait till the radiation after the irradiation preparation time Tg has elapsed. As described above, the irradiation preparation time Tg depends on the radiation generation apparatus 200 and may vary according to imaging conditions even for the same radiation generation apparatus 200. According to the present exemplary embodiment, the state transition mode determination unit 113 determines a suitable mode based on the magnitude relation between the irradiation preparation time Tg and the imaging preparation time Tp.

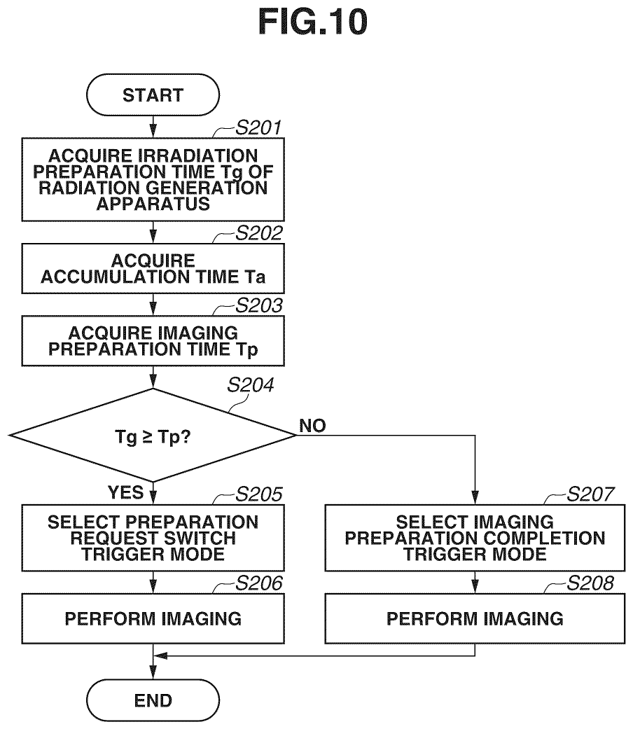

FIG. 10 is a flowchart illustrating an example of processing in a method for controlling the radiation imaging apparatus 100 according to the second exemplary embodiment of the present disclosure. More specifically, according to the present exemplary embodiment, the radiation imaging apparatus 100-1 illustrated in FIG. 7 performs the radiation imaging. FIG. 10 is a flowchart illustrating an example of processing in a method for controlling the radiation imaging apparatus 100-1.

When the processing of the flowchart illustrated in FIG. 10 is started, initially in step S201, the acquisition unit 111 acquires the irradiation preparation time Tg of the radiation generation apparatus 200.

In step S202, the acquisition unit 111 acquires the charge accumulation time Ta of the radiation imaging apparatus 100.

In step S203, the acquisition unit 111 acquires the imaging preparation time Tp based on the charge accumulation time Ta acquired in step S202.

Subsequently, in step S204, the state transition mode determination unit 113 determines whether the imaging preparation time Tp acquired in step S203 is equal to or less than the irradiation preparation time Tg acquired in step S201.

If the imaging preparation time Tp is equal to or less than the irradiation preparation time Tg (YES in step S204), the processing proceeds to step S205. In step S205, the state transition mode determination unit 113 selects the above-described preparation request switch trigger mode. Subsequently, in step S206, the radiation imaging apparatus 100 performs the radiation imaging in the preparation request switch trigger mode selected in step S205.

If the imaging preparation time Tp is larger than the irradiation preparation time Tg (NO in step S204), the processing proceeds to step S207. In step S207, the state transition mode determination unit 113 selects the above-described imaging preparation completion trigger mode. In step S208, the radiation imaging apparatus 100 performs the radiation imaging in the imaging preparation completion trigger mode selected in step S207.

When the processing in step S206 or S208 is completed, the processing in the flowchart illustrated in FIG. 10 is ended.

Although, in the example in FIG. 7, the state transition mode determination unit 113 is included inside the radiation imaging apparatus 100, the present exemplary embodiment is not limited thereto as long as a similar operation can be performed. For example, the state transition mode determination unit 113 may be included inside the console 300. In a case where the state transition mode determination unit 113 is included inside the console 300, the radiation imaging apparatus 100 acquires information about the determined mode from the state transition mode determination unit 113 of the console 300 and then performs subsequent processing.

While, in the second exemplary embodiment, the image data on the camera image captured by the camera 231 on the tube 230 is used in the imaging preparation completion trigger mode, the output data on the detection sensors may be used as in the first exemplary embodiment.

Referring to the example illustrated in FIG. 10, if the imaging preparation time Tp of the radiation imaging apparatus 100 is equal to or less than the irradiation preparation time Tg of the radiation generation apparatus 200 (YES in step S204), the processing proceeds to step S205. In step S205, the state control unit 110 of the radiation imaging apparatus 100 performs the following control. Specifically, in step S205, if a request for the radiation R irradiation preparation is issued to the radiation generation apparatus 200, the state control unit 110 performs control so that the state of the radiation imaging apparatus 100 is transitioned from the wait state to the imaging-ready state. Referring to the example in FIG. 10, if the imaging preparation time Tp is larger than the irradiation preparation time Tg of the radiation generation apparatus 200 (NO in step S204), the processing proceeds to step S207. In step S207, the state control unit 110 of the radiation imaging apparatus 100 performs the following control. Specifically, in step S207, if a condition related to the execution of the radiation imaging becomes a predetermined state as in the first exemplary embodiment, the state control unit 110 performs control so that the state of the radiation imaging apparatus 100 is transitioned from the wait state to the imaging-ready state.

According to the second exemplary embodiment, the above-described configuration makes it possible to perform suitable radiation imaging while maintaining power saving, as in the first exemplary embodiment. Thus, the radiation imaging apparatus 100 can perform the radiation imaging without degrading the operator's usability.

A third exemplary embodiment will be described below. In the following descriptions of the third exemplary embodiment, descriptions of elements common to the above-described first and second exemplary embodiments will be omitted, and elements different from the first and second exemplary embodiments will be described below.

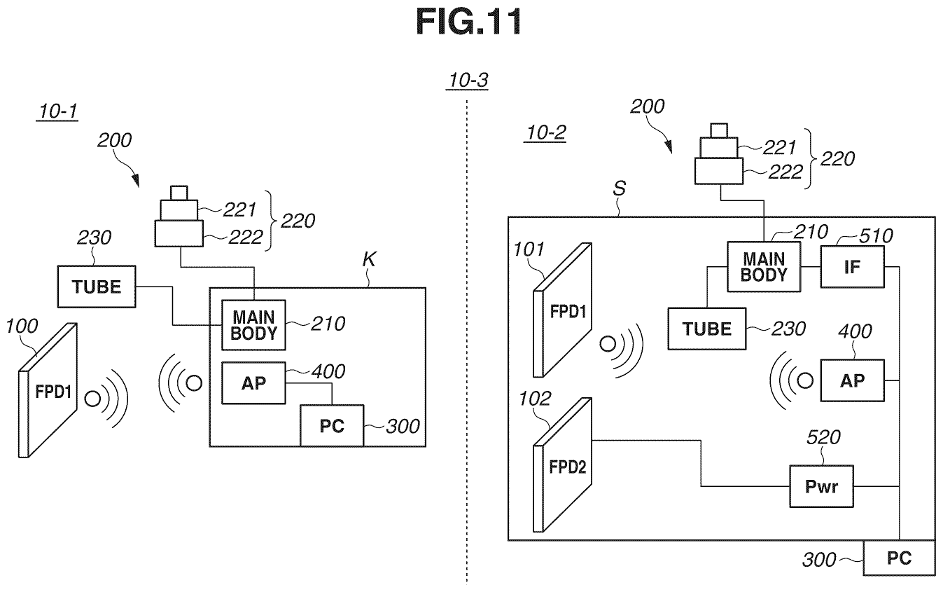

FIG. 11 illustrates an example of an overall configuration of a radiation imaging system 10-3 according to the third exemplary embodiment of the present disclosure. Referring to FIG. 11, components similar to those illustrated in FIGS. 1 and 7 are assigned the same reference numerals, and detailed descriptions thereof will be omitted. The radiation imaging system 10-3 according to the third exemplary embodiment illustrated in FIG. 11 includes the radiation imaging system 10-1 according to the first exemplary embodiment illustrated in FIG. 1 and the radiation imaging system 10-2 according to the second exemplary embodiment illustrated in FIG. 7.

According to the present exemplary embodiment, the radiation imaging apparatus 100 included in the radiation imaging system 10-1 and the radiation imaging apparatuses 100-1 and 100-2 included in the radiation imaging system 10-2 can be used in other radiation imaging systems. However, it is necessary to clarify which radiation imaging apparatus is connected to which radiation imaging system. For example, for wired communication via a cable such as Ethernet, the connection destination is clear. However, for wireless communication such as wireless LAN, the establishment of a connection to the intended network cannot be known simply by moving the radiation imaging apparatus 100. Thus, if the operator moves and uses the radiation imaging apparatus 100 under another radiation imaging system, the operator needs to exit the radiation imaging system before the movement and then enter the destination radiation imaging system (hereinafter this action is referred to as “check-in”). More specifically, the operator may perform a check-in operation by taking an intentional action using a dedicated communication module, such as infrared communication, Bluetooth®, and short-distance wireless communication, provided in the destination radiation imaging system. Alternatively, the operator may perform the check-in operation by once connecting a wire cable. The radiation imaging apparatus 100 may detect an approach to the destination radiation imaging system and then automatically perform the check-in operation without requiring the operator's intentional action. In such a case, however, care is required so as not to check in an unintended radiation imaging system.

During the check-in operation, information for participating in the network of the destination radiation imaging system is transmitted from the destination radiation imaging system to the radiation imaging apparatus 100 and then set to the radiation imaging apparatus 100. Examples of the information for participating in the network include the Internet Protocol (IP) address, Service Set Identifier (SSID), and the password of the wireless access point 400. Information for identifying the radiation imaging apparatus 100, for example, the Media Access Control (MAC) address, is transmitted to the destination radiation imaging system. Further, the imaging mode usable in the radiation imaging system is transmitted to the radiation imaging apparatus 100 and then set thereto through the check-in operation. For example, the generation apparatus I/F unit 510 which is an interface to the radiation generation apparatus 200 is disposed inside the radiographing room S, so that the radiation imaging apparatus 100 can receive a depression of the preparation request switch 221 from the radiation generation apparatus 200. Since the generation apparatus I/F unit 510 is not disposed inside or close to the visiting car K, the radiation imaging apparatus 100 cannot receive the depression of the preparation request switch 221. The internal configuration of the radiation imaging apparatus 100 according to the present exemplary embodiment is as illustrated in the radiation imaging apparatus 100 (100-1 and 100-2) in FIG. 8. The state transition mode determination unit 113 determines the state transition mode based on the information about the system configuration acquired in the check-in operation, the irradiation preparation time Tg, and the imaging preparation time Tp.

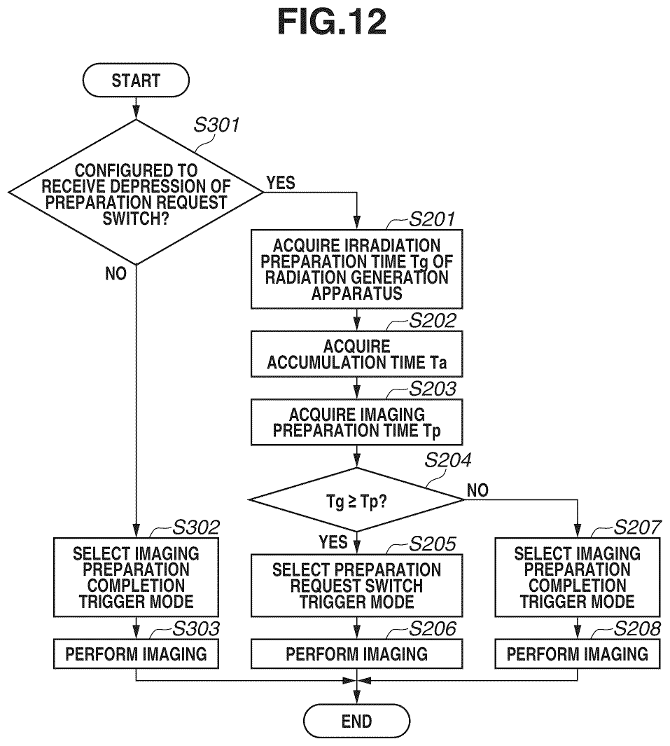

FIG. 12 is a flowchart illustrating an example of processing in a method for controlling the radiation imaging apparatus 100 according to the third exemplary embodiment of the present disclosure. In the flowchart illustrated in FIG. 12, processing steps similar to the processing steps in the flowchart illustrated in FIG. 10 are assigned the same step numbers, and detailed descriptions thereof will be omitted.

When the processing in the flowchart illustrated in FIG. 12 is started, initially in step S301, the state transition mode determination unit 113 determines whether the network system in which the radiation imaging apparatus 100 is currently participating is configured to receive depression of the preparation request switch 221.

If the network system in which the radiation imaging apparatus 100 is currently participating is configured so as not to receive depression of the preparation request switch 221 (NO in step S301), the processing proceeds to step S302. For example, if the network system is configured so as not to receive the depression of the preparation request switch 221, such as the radiation imaging system 10-1 (the radiation imaging system in the visiting car K), the processing proceeds to the processing of step S302. In step S302, the state transition mode determination unit 113 selects the imaging preparation completion trigger mode as in step S207. Subsequently, in step S303, the radiation imaging apparatus 100 performs the radiation imaging in the imaging preparation completion trigger mode selected in step S302.

If the network system in which the radiation imaging apparatus 100 is currently participating is configured to receive depression of the preparation request switch 221 (YES in step S301), the processing proceeds to step S201. For example, if the network system is configured to receive depression of the preparation request switch 221, such as the radiation imaging system 10-2 (radiation imaging system in the radiographing room S), the processing proceeds to step S201. The operations in step S201 and subsequent steps are similar to those in the flowchart illustrated in FIG. 10, and redundant descriptions thereof will be omitted.

According to the third exemplary embodiment, suitable radiation imaging is performable while maintaining power saving, like the first exemplary embodiment as in the first exemplary embodiment. Thus, the radiation imaging apparatus 100 can perform the radiation imaging without degrading the operator's usability.

While the above-described exemplary embodiments premise that the camera 231 is attached to the tube 230 of the radiation generation apparatus 200, the present exemplary embodiment is not limited to this configuration.

For example, the present exemplary embodiment may use a camera attached to the ceiling of the radiographing room S and, in visiting hospital beds with the visiting car K, use a network camera attached to each room. The type, pixel number, frame rate, and recording method of the camera 231 are not limited as long as information for executing the processing intended by the present disclosure can be acquired.

The present disclosure can also be achieved when a program for implementing at least one of the functions according to the above-described exemplary embodiments is supplied to a system or apparatus via a network or storage medium, and at least one processor in the computer of the system or apparatus reads and executes the program. The present disclosure can also be achieved by a circuit such as an application specific integrated circuit (ASIC) for implementing at least one function.

This program and a computer-readable storage medium storing the program are included in the present disclosure.

The above-described exemplary embodiments of the present disclosure are to be considered as illustrative in embodying the present disclosure, and are not to be interpreted as restrictive on the technical scope of the present disclosure. The present disclosure may be embodied in diverse forms without departing from the technical concepts or essential characteristics thereof.

The present disclosure makes it possible to perform suitable radiation imaging while maintaining power saving.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-150165, filed Sep. 15, 2023, which is hereby incorporated by reference herein in its entirety.

What is claimed is:

1. A radiation imaging apparatus configured to perform radiation imaging of a subject, the radiation imaging apparatus comprising:
an image generation unit configured to generate a radiation image based on an incident radiation; and
a control unit configured to, in a case where it is determined, based on a camera image captured by a camera and output data output from a detection sensor configured to detect at least either one of a position or a movement, that at least any one of conditions including a positional relation between the radiation imaging apparatus and a radiation generation apparatus configured to generate the radiation, a positional relation between the subject and the radiation imaging apparatus, or a posture of the subject becomes a predetermined state in the radiation imaging, perform control so that a transition is made from a wait state in which a lower power consumption is provided than in an imaging-ready state in which the radiation is detectable by the image generation unit, to the imaging-ready state.

2. The radiation imaging apparatus according to claim 1,
wherein the subject is positioned between a radiation irradiation unit of the radiation generation apparatus and the radiation imaging apparatus, and
wherein a positional relation between the radiation generation apparatus and the radiation imaging apparatus is a positional relation between the radiation irradiation unit of the radiation generation apparatus and the radiation imaging apparatus.

3. The radiation imaging apparatus according to claim 1, wherein the camera is disposed on a radiation irradiation unit of the radiation generation apparatus.

4. The radiation imaging apparatus according to claim 1, wherein the detection sensor includes at least any one of an acceleration sensor, a gyro sensor, or an earth magnetism sensor.

5. The radiation imaging apparatus according to claim 1, wherein, in a case where the at least any one of the conditions deviates from the predetermined state, the control unit performs control so that a transition from the imaging-ready state to the wait state is made.

6. The radiation imaging apparatus according to claim 1, wherein, in a case where, after the control unit performs control so that the transition to the imaging-ready state is made, at least any one of the conditions deviates from the predetermined state, the control unit performs control so that a notification unit issues a notification of the deviation.

7. The radiation imaging apparatus according to claim 6, wherein the notification unit issues the notification by using at least either one of a display or an audio output.

8. The radiation imaging apparatus according to claim 6, wherein the notification unit is disposed on at least any one of a control apparatus configured to control the radiation imaging apparatus, the radiation imaging apparatus, or the radiation generation apparatus.

9. The radiation imaging apparatus according to claim 1, wherein, in a case where, after the control unit performs control so that the transition to the imaging-ready state is made, the radiation image is transmitted to a control apparatus configured to control the radiation imaging apparatus, the control unit performs control so that a transition to the wait state is made.

10. The radiation imaging apparatus according to claim 1, wherein, in a case where, after the control unit performs control so that the transition to the imaging-ready state is made, the image generation unit reads an electrical signal related to the radiation image, the control unit performs control so that a transition to the wait state is made.

11. The radiation imaging apparatus according to claim 1,
wherein, in a case where an imaging preparation time of the radiation imaging apparatus is equal to or less than an irradiation preparation time for the radiation to be generated by the radiation generation apparatus, the control unit performs control so that the transition from the wait state to the imaging-ready state is made in a case where an irradiation preparation request for the radiation is issued to the radiation generation apparatus, and
wherein, in a case where the imaging preparation time of the radiation imaging apparatus is larger than the irradiation preparation time for the radiation to be generated by the radiation generation apparatus, the control unit performs control so that the transition from the wait state to the imaging-ready state is made in a case where at least any one of the conditions becomes the predetermined state.

12. The radiation imaging apparatus according to claim 1, wherein the predetermined state is determined based on an imaging order.

13. A radiation imaging system, comprising:
the radiation imaging apparatus according to claim 1; and
the radiation generation apparatus.

14. A control method for a radiation imaging apparatus configured to perform radiation imaging of a subject, the radiation imaging apparatus including an image generation unit configured to generate a radiation image based on an incident radiation, the control method comprising:
in a case where it is determined, based on a camera image captured by a camera and output data output from a detection sensor configured to detect at least either one of a position or a movement, that at least any one of conditions including a positional relation between the radiation imaging apparatus and a radiation generation apparatus configured to generate the radiation, a positional relation between the subject and the radiation imaging apparatus, or a posture of the subject becomes a predetermined state in the radiation imaging, performing control so that a transition is made from a wait state in which a lower power consumption is provided than in an imaging-ready state in which the radiation is detectable by the image generation unit, to the imaging-ready state.

15. A storage medium storing a program for causing a computer to execute the control method according to claim 14.
